(19) United States
(12) Patent Application Publication
(10) Pub. No.: US 2026/0220493 A1
(43) Pub. Date: Jul. 30, 2026

(54) Machine Learning-Based Information Management Engine

(71) Applicant: Oracle International Corporation, Redwood Shores, CA (US)

(72) Inventors: Allen Roshan D’Souza, Houston, TX (US); Dipen Ashvinkumar Joshi, Katy, TX (US); Ankur Handa, Santa Clara, CA (US); Shovan Sutar, Palo Alto, CA (US); Rene Lynn Holtam, Erie, CO (US); Mohammed Abdul Rafey, Hyderabad (IN); Abhinay Nomula, Hyderabad (IN); Denise E. Hagerty, New Braunfels, TX (US); Venkata Narsimha Rao Gurrapu Srinivas, Hyderabad (IN)

(73) Assignee: Oracle International Corporation, Redwood Shores, CA (US)

(21) Appl. No.: 19/308,534

(22) Filed: Aug. 25, 2025

Related U.S. Application Data
(60) Provisional application No. 63/750,916, filed on Jan. 29, 2025.

(51) Int. Cl. G06N 5/022

(52) U.S. Cl. CPC G06N 5/022

(57) ABSTRACT

A system that trains a machine learning model to determine capture levels for target computations is disclosed. The system utilizes training data encompassing attribute sets and information levels for various computation types. For a form field value computation, the system determines associated attributes. The trained model processes these attributes to establish an appropriate information storage level. Based on this level, the system selects a relevant subset of information related to the computation or its result. The system then stores this selected subset in association with the computed value. The system uses feedback to retrain the model to enhance its performance.

### INCORPORATION BY REFERENCE; DISCLAIMER

The following application is hereby incorporated by reference application no. 63/750,916, filed on Jan. 29, 2025, entitled “Information Management Engine”. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to information management systems.

### BACKGROUND

Information management systems handle complex calculations, data processing, and information management in specialized domains. Information management systems process large volumes of data, apply intricate rules and formulas, and generate outputs based on specific requirements or regulations. These systems integrate data collection, analysis, calculation, and reporting functions within a unified framework.

Information management systems often operate in domains with strict regulatory requirements, evolving rules, and the need for precise calculations. Taxes, financial services, healthcare administration, and regulatory compliance represent areas where such systems find extensive application.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for information management in accordance with one or more embodiments;

FIG. 2 illustrates an example set of operations for information management in accordance with one or more embodiments;

FIG. 3 illustrates a machine learning-guided information retention example in accordance with one or more embodiments;

FIG. 4 illustrates a tax calculation information management example in accordance with one or more embodiments; and

FIG. 5 shows a block diagram that illustrates a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. INFORMATION MANAGEMENT ARCHITECTURE
3. TRAINING A MACHINE LEARNED MODEL FOR INFORMATION MANAGEMENT
4. MACHINE LEARNING-GUIDED INFORMATION RETENTION EXAMPLE
5. TAX CALCULATION INFORMATION MANAGEMENT EXAMPLE
6. PRACTICAL APPLICATIONS, ADVANTAGES & IMPROVEMENTS
7. MISCELLANEOUS; EXTENSIONS
8. HARDWARE OVERVIEW

### 1. GENERAL OVERVIEW

One or more embodiments train a machine learning model to determine appropriate levels of information to capture for a computation. The model learns from training data, including attributes of computation types and associated information levels. By analyzing attributes of specific computations, the trained model recommends information retention and display strategies. The system applies these recommendations to select and store subsets of information for computed values and data management efficiency.

One or more embodiments adapt information storage based on computation characteristics. For different fields in a form, the system determines attribute sets associated with respective computations. The trained model evaluates these attributes to specify distinct information levels for computed values. Consequently, the system selects and stores information subsets of varying detail for different computations, ensuring context-appropriate data retention. Computation characteristics, used for selecting the information level, may include a complexity of the computation, a computation type, a frequency with which a rule used for the computation has been historically used, and a number of data sources associated with the computation. The computation characteristics may further include a date of the computation and/or date(s) associated with dataset(s) used for the computation. The system may lower the information level over time, resulting in deletion of some information used for performing a computation as time passes while retaining the computed value itself.

One or more embodiments monitor user interaction and feedback associated with previously computed values to select a level of information to store with future computations. The system may determine a frequency with which a computed value is accessed and/or a number of uses of the computed value. The system selects a level of information for other computed values, with similar characteristics as the prior computed value, that is proportionate to the access frequency or number of uses of the prior computed value. Accordingly, computed values that are likely to be frequently accessed or likely to have significant use are stored with a high level of information. The system may monitor the use of computed values to determine a level of user confusion, issues, audits etc. associated with prior computed values. The system selects a level of information for other computed values, with similar characteristics as the prior computed values, that is proportionate to the level of confusion, issues, audits, etc. Accordingly, computed values that are likely to cause confusion, issues, audits, etc. are stored with a high level of information.

One or more embodiments enhance computation transparency through selective information capture. The system stores various details, such as explanations, sub-computations, and sub-values, used in calculations. When users request additional information about a computed value, the system presents the stored subset of relevant details. This approach balances comprehensive documentation with efficient data management.

One or more embodiments refine the machine learning model with user feedback. Upon receiving requests for additional information about computed values, the system retrains the model. The retraining process incorporates new data associating computations with adjusted information levels based on user needs. This iterative improvement ensures the model's recommendations align with user expectations over time.

One or more embodiments improve information storage for calculations. In scenarios involving determined facts and conditional calculations based on those facts, the system selectively stores a subset of this information. The stored subset includes some, but not all, of the determined facts and conditional calculations. This approach is particularly useful for computations involving regulations and user-specific conditions, balancing detail with efficiency.

One or more embodiments described in this Specification and/or recited in the claims may not be included in this General Overview section.

### 2. INFORMATION MANAGEMENT ARCHITECTURE

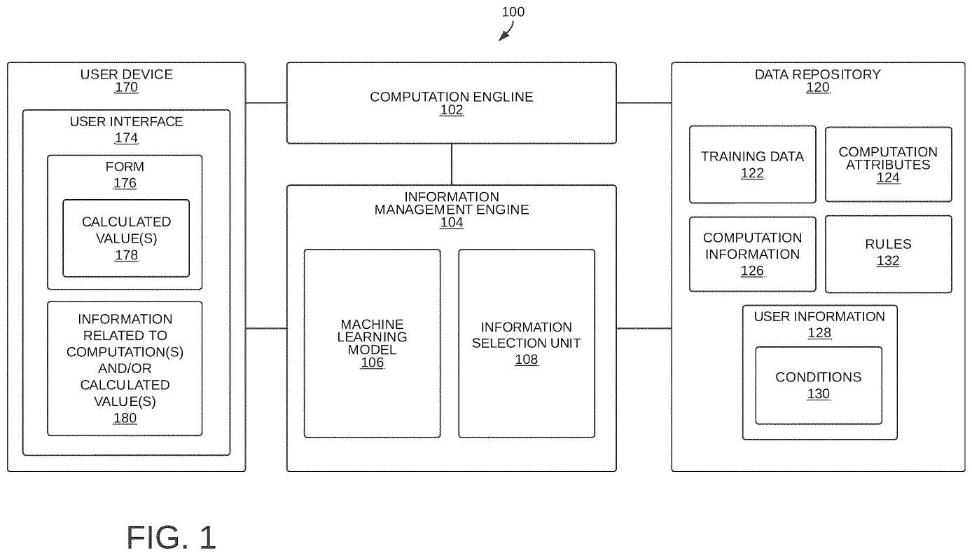

FIG. 1 illustrates a system 100 for information management in accordance with one or more embodiments. System 100 leverages machine learning techniques to determine appropriate levels of information capture for various computations, facilitates efficient data management, enhances transparency in calculation processes, and adapts to user needs through feedback-driven improvements.

As illustrated in FIG. 1, system 100 comprises computation engine 102, information management engine 104, machine learning model 106, information selection unit 108, data repository 120, user device 170, user interface 174, form 176, calculated value(s) 178, and information related to computation(s) and/or calculated value(s) 180. Data repository 120 further includes training data 122, computation attributes 124, computation information 126, user information 128, conditions 130, and rules 132. In one or more embodiments, system 100 may include more components or fewer components than the components illustrated in FIG. 1.

In an embodiment, computation engine 102 calculates values for fields in forms based on rules and input data. The engine processes user-provided information and applies domain-specific regulations to derive accurate results. For tax applications, the computation engine functions as a tax calculator, interpreting tax codes and policies to determine precise tax values, liabilities, refunds, or withholdings.

In an embodiment, information management engine 104 executes a series of operations to control information capture and presentation in computational systems. Information management engine 104 monitors queries associated with previously computed values for respective fields of a form. Forms processed by the engine include fields that calculate values based on rules and input data. Information management engine 104 tracks user interactions and information requests related to calculated results displayed in form fields. Information management engine 104 examines these queries to extract patterns and insights about user information needs. Information management engine 104 then determines types of information requested for previously computed values based on the monitored queries. Information management engine 104 sorts user queries into distinct information types, such as calculation steps, input data sources, or applied rules. Information management engine 104 tracks the frequency of different query categories.

In an embodiment, information management engine 104 processes the aggregated query data to identify recurring themes and priorities in user information needs. Based on the types of information requested for previously computed values, information management engine 104 determines levels of information to be stored and/or displayed in relation to future computations and future computed values. Information management engine 104 employs machine learning model 106 to analyze historical query patterns and predict likely information needs for various computation scenarios. These predictions inform decisions about the depth and breadth of information to capture and/or display for different calculation types.

In an embodiment, information management engine 104 trains machine learning model 106 to compute, based on attributes of a computation and a computed value, a level of information to store for computations and computed values. Training data includes historical computations, their attributes, and the corresponding levels of display information based on past user queries. Machine learning model 106 learns to associate computation characteristics with appropriate information retention strategies. Following model training, the engine applies machine learning model 106 to attributes of a target computation type and a target computed value to determine and select a level of information. Machine learning model 106 analyzes various factors, such as computation complexity, domain specificity, and historical query patterns, to output a recommended information retention level. Machine learning model 106 then selects a subset of information corresponding to the target computation and target computed value based on the selected level of information. Selection criteria balance comprehensiveness with efficiency, capturing sufficient detail to address likely user queries while avoiding unnecessary data storage.

In an embodiment, information management engine 104 implements feedback mechanisms to continuously improve its performance. Information management engine 104 monitors for user feedback related to the provided information subsets. Upon receiving sufficient feedback, the engine initiates a retraining process for the machine learning model. Feedback data augments the training dataset, allowing information management engine 104 to adapt to evolving user needs and improve its information level predictions over time. Through these interconnected operations, information management engine 104 creates an adaptive system for intelligent information capture and presentation in computational workflows.

In an embodiment, information selection unit 108 selects and supplies information to users for values of a form as determined by machine learning model 106. Information selection unit 108 provides users with relevant information about calculated values in a form. Information selection unit 108 receives input from machine learning model 106 and uses predictions by machine learning model 106 to guide information retrieval, presentation, and/or storage. Information selection unit 108 interprets the machine learning model's output, translating prediction scores or classifications into concrete information selection strategies. Information selection unit 108 accesses computation information 126, including calculation details, contextual information, and supporting documentation. Information selection unit 108 filters and prioritizes available information based on the specificity and depth recommendations provided by the machine learning model. In an embodiment, information selection unit 108 selects the extent of information for a calculation to be stored as computation information for a field of a form.

In an embodiment, training data 122 is stored within data repository 120. Training data 122 provides input for machine learning model 106. Training data 122 includes datasets representing diverse scenarios and use cases. Training data 122 undergoes regular updates and refinements to improve accuracy and relevance of machine learning outcomes. Training data 122 includes labeled examples, test cases, and validation sets to support comprehensive model training and evaluation.

In an embodiment, computation attributes 124 define characteristics and parameters for calculations performed within system 100. Computation attributes 124 specify input variables, algorithmic steps, and output formats for various computational tasks.

In an embodiment, computation information 126 includes details about specific computational processes and their outcomes. Computation information 126 records intermediate steps, decision points, related rules, and other information as well as final results of calculations performed by system 100.

In an embodiment, user information 128 is stored within data repository 120. User information 128 encompasses personal data, preferences, and historical interactions pertinent to users. For example, for tax systems, user information 128 includes personal information for calculating relevant tax calculations. User information 128 includes conditions 130 that guide decision-making processes and system behavior. Conditions 130 define specific circumstances relevant to rules 132.

In an embodiment, rules 132 encode business logic, regulatory requirements, and best practices into actionable directives for system 100. Rules 132 govern data processing, calculation methodologies, and output formats across various functions of computation engine 102 and information management engine 104. In a tax example, the rules are tax rules relevant to computations.

In an embodiment, user device 170 connects to computation engine 102 and information management engine 104. User device 170 facilitates interaction with computation engine 102 and information management engine 104 through user interface 174. User device 170 is one of various hardware platforms, including desktop computers, laptops, tablets, and smartphones.

In an embodiment, user interface 174 presents information and controls to users of computation engine 102 and information management engine 104 on user device 170. In an embodiment, form 176 appears within user interface 174. Form 176 allows users to input data and view results generated by computation engine 102 and information management engine 104. In an embodiment, calculated value(s) 178 displays on a field of form 176. Calculated value(s) 178 represents outcomes of computations performed by system 100.

In an embodiment, information related to computation(s) and/or calculated value(s) 180 appears alongside calculated value(s) 178 on form 176 when selected by the user. Information 180 provides context, explanations, or additional details about calculations and results produced by system 100. Information management engine 104 provides the level of information 180 as determined by machine learning model 106.

In one or more embodiments, data repository 120 is any type of storage unit and/or device (e.g., a file system, database, collection of tables, or any other storage mechanism) for storing data. Furthermore, data repository 120 may include multiple different storage units and/or devices. The multiple different storage units and/or devices may or may not be of the same type or located at the same physical site. Furthermore, data repository 120 may be implemented or executed on the same computing system as information management engine 104. Additionally, or alternatively, data repository 120 may be implemented or executed on a computing system separate from information management engine 104. Data repository 120 may be communicatively coupled to information management engine 104 via a direct connection or via a network.

In one or more embodiments, computation engine 102, information management engine 104, machine learning model 106, information selection unit 108, data repository 120, user device 170, and user interface 174 refer to hardware and/or software configured to perform operations described herein for information storage and retrieval.

In an embodiment, computation engine 102, information management engine 104, machine learning model 106, information selection unit 108, data repository 120, user device 170, and user interface 174 are implemented and/or stored on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. TRAINING A MACHINE LEARNED MODEL FOR INFORMATION MANAGEMENT

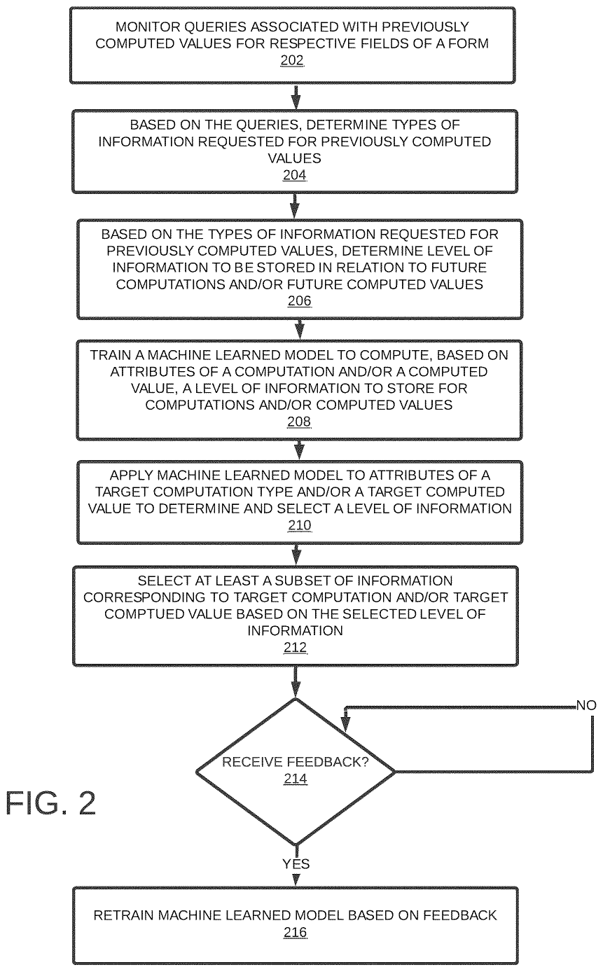

FIG. 2 illustrates an example set of operations for information management in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, when computing taxes, the system considers government rules, employer-specific factors, geographic elements, and employee attributes. The system generates a detailed worksheet showing steps of the tax calculation process, highlighting any variations or user interventions that affected the result. For example, if the system calculates $10 in state income tax for California, the system provides a comprehensive explanation of how that specific amount was derived. The system exposes the entire calculation process, including rules and directions provided to the payroll engine. This allows users to understand precisely how a particular tax amount was computed, eliminating uncertainty and questions about discrepancies.

In an embodiment, the system provides an integrated view of relevant information from various sources. When a user selects a particular form, number, or data element, the system dynamically updates visualizations and relevant information panels. Components fade in or out based on their relevance to the selected item, providing clear visual cues about data relationships and origins. In an example, when a user selects an education credit amount on a tax form, the system display related rules, organization information, and associated W-2 data. The system's interface allows seamless navigation between interconnected pieces of information, retaining context as users move between different views.

In an embodiment, the system processes computations with layered data and logic. The system determines facts for the computed value, establishing input data and context. These facts underpin subsequent calculations and decision-making. The system executes conditional calculations that rely on the determined facts, applying rules based on specific fact combinations. When assembling the subset of information, the system selectively includes some determined facts and conditional calculations. Intelligent filtering algorithms identify crucial elements for user understanding, omitting less significant details. The system balances comprehensiveness with clarity, providing essential insights without overwhelming users.

In an embodiment, the system processes user-specific calculations based on regulatory frameworks. The system applies a set of regulations and conditions tailored to a specific user when performing conditional calculations. These regulations encompass legal requirements, policy guidelines, and user-specific parameters that influence the computation outcome. The system incorporates the user's unique circumstances, such as demographic information, financial status, or geographical location, into the calculation process. For the computation, the system identifies and utilizes a computation type as part of attributes. The computation type serves as a key characteristic, guiding the system's approach to information selection and presentation. By recognizing the computation type, the system adapts its processing methods and output formats to align with the nature of the calculation being performed.

In an embodiment, the system processes user interactions related to computed values and their associated information. The system receives a request for details associated with a computed value, initiating a retrieval process for relevant information. Requests originate from various user interface elements, such as clickable icons, context menus, or voice commands. The system interprets the received request, extracting key parameters to guide the information retrieval process. Upon receiving the request, the system accesses a data store that includes pre-selected subsets of information for different computed values. The system locates the subset of information corresponding to the computed value, matching the request parameters with stored data identifiers. Once the appropriate subset is identified, the system prepares the information for presentation to the user.

In an embodiment, the system uses adaptive information capture and/or information presentation for fields in a form. A machine learning model analyzes attributes of specific calculations to determine a level of detail retention or display. The adaptive approach significantly enhances data efficiency in large-scale calculation systems, storing or displaying comprehensive details for calculations, while storing or displaying less information for routine computations. The system is useful for a variety of information systems, including tax calculation, financial reporting, regulatory compliance, and healthcare data management. In these domains, the system's ability to selectively capture and present computation details improves transparency, facilitates audits, and improves data storage across varied computational processes.

In an embodiment, a system monitors queries associated with previously computed values of fields of a form (Operation 202). The forms includes fields used to calculate values. The monitoring process tracks user interactions and information requests related to calculated results displayed in form fields. The system examines these queries to extract patterns and insights about user information needs.

In an embodiment, a tax engine monitors queries associated with previously computed values for respective fields of tax forms. The tax engine calculates values for multiple fields across various tax forms. Monitoring functionality within the system tracks user interactions and information requests related to calculated results displayed in the tax form fields. Users submit questions about the support or justification for specific tax calculations shown in form fields. The tax engine examines these user queries and extracts patterns and insights about user information needs regarding tax computations. Over time, the system builds a comprehensive understanding of common user questions and areas where additional explanation is often required.

In an embodiment, query patterns reveal fields or calculation types that generate more frequent user inquiries. The tax engine leverages these insights to provide relevant supporting information alongside calculated values. Machine learning models trained on historical query data predict likely information needs for different tax calculation scenarios. The tax engine continuously refines its understanding of user information requirements through ongoing query analysis. Aggregate query data informs improvements to calculation explanations and documentation across the tax preparation workflow. By closely monitoring and analyzing user queries, the tax engine system evolves to better meet information needs and enhance transparency in tax computations.

In an embodiment, the system determines types of information requested for previously computed values based on the monitored queries (Operation 204). The system categorizes and tallies the various information requests to identify common themes and priorities in user inquiries. The system categorizes user inquiries into distinct information types, such as calculation steps, input data sources, or applied rules.

In an embodiment, the system performs preliminary operations to establish a foundation for training the machine learning model. The system initiates a monitoring process focused on user queries related to various computation types. Monitoring encompasses capturing and logging user interactions, questions, and information requests across diverse computational scenarios. The system categorizes incoming queries based on the associated computation types, creating distinct sets for analysis. As queries accumulate, the system applies natural language processing techniques to extract key themes and information needs from user inquiries. The system then conducts statistical analysis on the categorized query sets, identifying patterns and trends in user information requirements for the computation types. Based on the analyzed query data, the system determines appropriate information levels to associate with different computation types. Information levels represent the depth and breadth of details users typically require for specific calculations. The system establishes a spectrum of information levels, ranging from minimal explanations for straightforward computations to comprehensive breakdowns for complex or high-stakes calculations. Through these preprocessing steps, the system generates a structured dataset linking computation types to information levels.

In an embodiment, the system determines a level of information to be stored in relation to future computations and/or future computed values (Operation 206). The system adjusts storage or display parameters based on observed user behavior, balancing comprehensive record-keeping with system efficiency. User behavior is monitored through various interaction points within the system interface. The system tracks user clicks, time spent on different information sections, frequency of accessing detailed explanations, and patterns of follow-up queries. To process user behavior data, the system employs analytics to aggregate interaction metrics across multiple users and computation types, identifying trends and preferences in information consumption. The system calculates engagement scores for different levels of computational detail, measuring how often users access and interact with various depths of information.

In an embodiment, the system trains a machine learned model to compute a level of information to store for computations and/or computed values (Operation 208). The model training process utilizes historical data on computation attributes, resulting values, and associated information requests. A machine learning algorithm identifies correlations and patterns to determine information retention or display strategies.

In an embodiment, the system determines multiple aspects of information related to computed values and their underlying calculations. The system identifies an amount of explanation associated with a computed value, providing users with appropriate context and detail. Explanation levels range from brief summaries to comprehensive breakdowns, tailored to user needs and query patterns. The system also identifies sub-computations used for the computation, revealing the step-by-step process that leads to the final result. These sub-computations encompass intermediate calculations, conditional logic branches, and applied rules or formulas. Furthermore, the system identifies sub-values used for executing the computation, exposing the granular data points that contribute to the calculated outcome. Sub-values include input parameters, constants, and dynamically determined factors that influence the computation.

In an embodiment, the system associates information levels with depth metrics for machine learning model training. The system creates a numerical scale to measure explanation comprehensiveness for different computation types. Depth metrics encompass calculation steps exposed, data point granularity, and contextual information extent. The system defines a range of depth metric values, from basic to detailed explanations. These metrics serve as target variables in model training, enabling learning of relationships between computation attributes and information detail levels. The system generates labeled training data, pairing computation instances with information level scores. As the model processes this data, the system guides pattern recognition linking computation characteristics to depth metric values. This approach allows fine-grained control over information presentation, facilitating tailored explanations. The system's integration of depth metrics creates a mechanism for predicting information levels across computational scenarios.

In an embodiment, the system applies the trained machine learning model to attributes of a target computation type and/or a target computed value to determine and select a level of information (Operation 210). The system initiates this process by generating feature vectors from the attributes of the target computation or computed value. These feature vectors encapsulate key characteristics, such as computation complexity, domain specificity, user role associations, and historical query frequencies. To construct feature vectors, the system employs numerical encoding and categorical variable transformation techniques, including normalization and one-hot encoding. The system then feeds these prepared feature vectors into the trained machine learning model, which typically includes of multiple layers of neurons or decision trees, depending on the specific algorithm employed.

In an embodiment, the output of the model is a multi-dimensional vector representing different aspects of information storage and presentation. This output vector includes various elements, such as an overall depth score for information retention, probabilities for including specific types of information, recommended retention periods, and suggested presentation formats. The system interprets this output vector to make concrete decisions about information storage and presentation, allocating resources and preparing explanation templates based on the scores and probabilities generated.

In an embodiment, the system selects at least a subset of information corresponding to the target computation and/or target computed value based on the selected level of information (Operation 212). The machine learning model outputs a multidimensional vector for each computation, including an overall information depth score (e.g., on a scale of 1 to 10) and individual scores for various information categories (e.g., input parameters: 0.9; intermediate steps: 0.7; regulatory references: 0.8). The system maintains a predefined hierarchy of information types for each computation, with each type assigned a threshold score. For example, a threshold of 0.75 might be set for including detailed audit trails, while a threshold of 0.5 could be used for summary-level information. The system compares the model's output scores against these thresholds to determine which information types to include in the subset. Additionally, the system considers the overall depth score to adjust the granularity of selected information. For instance, an overall score of 8 out of 10 might trigger the inclusion of more detailed breakdowns and explanations across all selected information types. In an embodiment, the system incorporates a feedback loop to continuously improve its performance. Users provide input on the relevance and usefulness of stored information through various feedback mechanisms. The feedback collection process enables ongoing refinement of the system's information management strategies.

In an embodiment, the system checks if a sufficient level of feedback is received (Operation 214). If a sufficient level of feedback is not received in operation 214, then the system returns to operation 214. If a sufficient level of feedback is received in operation 214, then the system proceeds to operation 216.

In an embodiment, if a sufficient level of feedback is received, the system retrains the machine learned model based on received feedback (Operation 216). The system continuously monitors and accumulates user feedback through various channels, including explicit ratings, follow-up queries, and implicit indicators such as time spent reviewing provided information. When the volume of new feedback data reaches a predetermined threshold, the system initiates the retraining process. This process begins with data preparation, where the system aggregates and preprocesses the accumulated feedback, normalizing ratings and encoding qualitative feedback into numerical features. The system then augments the original training dataset with this new feedback data, ensuring a balance between historical performance and recent user interactions. To update the model efficiently, the system employs incremental learning techniques, fine-tuning the existing model architecture rather than retraining from scratch.

### 4. MACHINE LEARNING-GUIDED INFORMATION RETENTION EXAMPLE

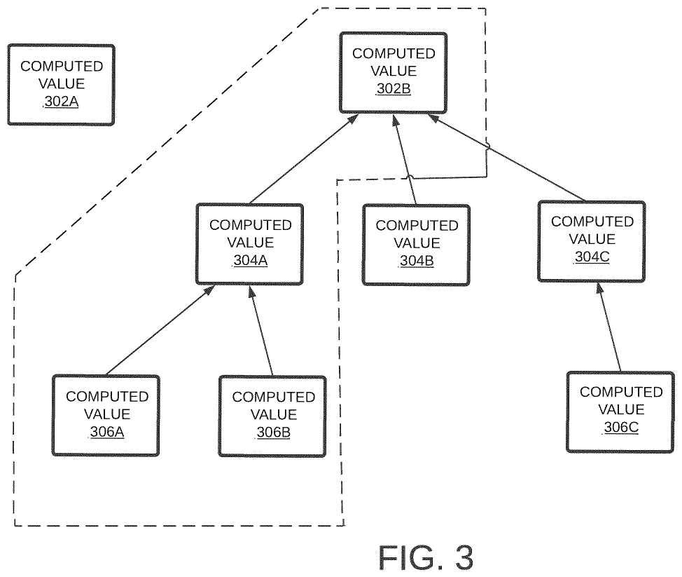

FIG. 3 illustrates a machine learning-guided information retention example in accordance with one or more embodiments. The example shown in in FIG. 3 should not be construed as limiting the scope of one or more embodiments.

In an embodiment, a system for managing computation information utilizes a hierarchical network of computed values 302A, 302B, 304A, 304B, 304C, 306A, 306B, and 306C as depicted in FIG. 3. The network illustrates dependency relationships between multiple computed values arranged in different levels, with directional arrows indicating how lower-level computed values contribute to higher-level computed values through a computational flow.

In an embodiment, the dotted lines surrounding a subset of the computational network represent a visual delineation of information selected for storage in relation to computed value 302B. The selection boundary, determined by the machine learning model 106, indicates which supporting computations and intermediate values the system that are preserved along with detailed explanations, sub-computations, and contextual information. The dotted enclosure demonstrates the system's selective information retention strategy, highlighting elements deemed most relevant for understanding computed value 302B.

In an embodiment, the system determines appropriate levels of information to be stored for computations based on attributes analyzed by machine learning model 106. For computed value 302B, the system has identified computed values 304A, 306A, and 306B as requiring detailed information retention, as indicated by their inclusion within the dotted boundary. These elements represent the computational path that most significantly influences the final result and is most likely to be subject to user queries. The system's operations are thus transparent to users, enabling them to understand exactly why a particular value was computed rather than having to trust the output without explanation.

In an embodiment, the dotted boundary illustrates the system's intelligent filtering process for information storage. Rather than storing comprehensive details for all computations that contribute to computed value 302B, the system selectively preserves information for the subset within the dotted lines. The system balances comprehensive documentation with efficient data management, focusing resources on components with greater explanatory value to a user.

In an embodiment, the system implements the machine learning model's recommendations by selecting specific computation details within the dotted boundary to preserve. These details may include step-by-step calculation processes, sub-computations, intermediate values, explanations, determined facts, conditional calculations, and applied rules relevant to computations inside the boundary. For computations outside the boundary, such as computed values 304B, 304C, and 306C, the system stores less supporting information.

In an embodiment, the system dynamically adjusts the dotted boundary based on user feedback. When users request additional information about specific computed values initially outside the boundary, the machine learning model updates its recommendations to expand the boundary and increase information retention for those calculations in future instances, creating a continuously improving information management system. The feedback mechanism enables the system to learn from user interactions and progressively enhance its information retention strategy, focusing on areas that generate the most queries or confusion.

### 5. TAX CALCULATION INFORMATION MANAGEMENT EXAMPLE

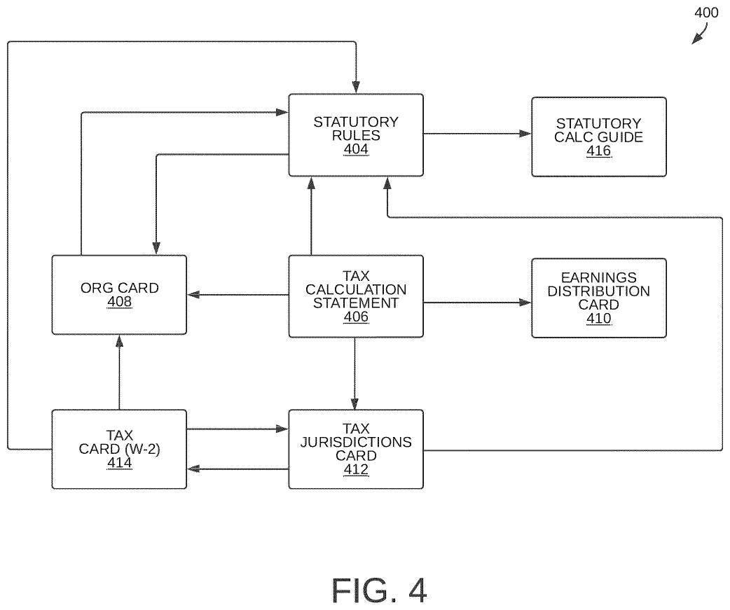

FIG. 4 illustrates a tax calculation information management example in accordance with one or more embodiments. The example shown in FIG. 4 should not be construed as limiting the scope of one or more embodiments.

In an embodiment, FIG. 4 illustrates an integrated information management system that demonstrates dynamic relationships between multiple computational components within a tax calculation environment. System 400 comprises statutory rules 404, tax calculation statement 406, org card 408, earnings distribution card 410, tax jurisdictions card 412, tax card W-2 414, and statutory calc guide 416. These components form interconnected data structures that enable selective information capture and presentation based on machine learning model recommendations.

In an embodiment, statutory rules 404 serve as foundational regulatory data sources that encode government-mandated tax calculations, rate tables, and compliance requirements. Statutory rules 404 maintain current tax legislation parameters including withholding percentages, income thresholds, deduction limits, and jurisdiction-specific variations.

In an embodiment, tax calculation statement 406 functions as a central computation result display that presents detailed breakdowns of tax calculations performed by computation engine 102. Tax calculation statement 406 receives input from multiple data sources and generates step-by-step explanations of calculation processes.

In an embodiment, org card 408 stores employer-specific configuration data that influences payroll calculations, including organizational structures, relevant states, benefit plans, union agreements, and company-specific tax policies.

In an embodiment, earnings distribution card 410 manages employee compensation data, including salary components, bonus allocations, stock options, and other income sources that affect tax calculations. Earnings distribution card 410 tracks temporal changes in compensation structures and maintains historical records for year-end tax reporting.

In an embodiment, tax jurisdictions card 412 maintains geographic and legal jurisdiction data that determines applicable tax rates and rules based on employee work locations and residency status. Tax jurisdictions card 412 processes multi-state tax scenarios, local municipality requirements, and cross-border taxation rules.

In an embodiment, tax card W-2 414 represents employee-specific tax withholding preferences and status information derived from federal tax forms, including filing status, exemption claims, and additional withholding requests. Tax card W-2 414 interfaces with statutory rules 404 to apply personalized tax calculations while maintaining compliance with federal reporting requirements.

In an embodiment, statutory calc guide 416 provides computational methodologies and algorithmic procedures for implementing tax calculations according to regulatory specifications. Statutory calc guide 416 translates legal tax requirements into executable calculation processes and maintains version control for regulatory updates.

In an embodiment, directional relationships between components indicate information flow patterns where statutory rules 404 and statutory calc guide 416 provide foundational calculation parameters that influence tax calculation statement 406 generation. Tax jurisdictions card 412, org card 408, earnings distribution card 410, and tax card W-2 414 contribute contextual data that personalizes calculation results displayed in tax calculation statement 406.

In an embodiment, an information management engine monitors user interactions with the components to identify patterns in information requests and calculation explanations. Feedback mechanisms capture user satisfaction with information detail levels provided for different component types, enabling continuous refinement of storage and presentation strategies. The machine learning model incorporates the feedback to adjust information retention recommendations for similar calculation scenarios in future processing cycles.

### 6. PRACTICAL APPLICATIONS, ADVANTAGES, & IMPROVEMENTS

The information management engine offers significant practical applications and advantages in the field of computational data management and transparency. By implementing a machine learning model to determine appropriate levels of information capture and/or display, the system achieves a technical improvement in computer networks by improving data storage and retrieval processes. The adaptive approach to information retention allows for efficient use of network resources, reducing unnecessary data transfer and storage burdens. Users benefit from enhanced transparency for calculations, for the system provides tailored explanations and details for computed values without overwhelming storage systems or compromising performance. The feedback-driven model refinement process ensures continuous improvement in the system's ability to meet user needs, further enhancing the efficiency of data management across the network. In scenarios involving intricate regulatory calculations or user-specific conditions, the selective storage of facts and conditional calculations strike a balance between comprehensive documentation and network efficiency. These improvements collectively contribute to a more responsive, resource-efficient, and user-friendly computational environment within computer networks.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

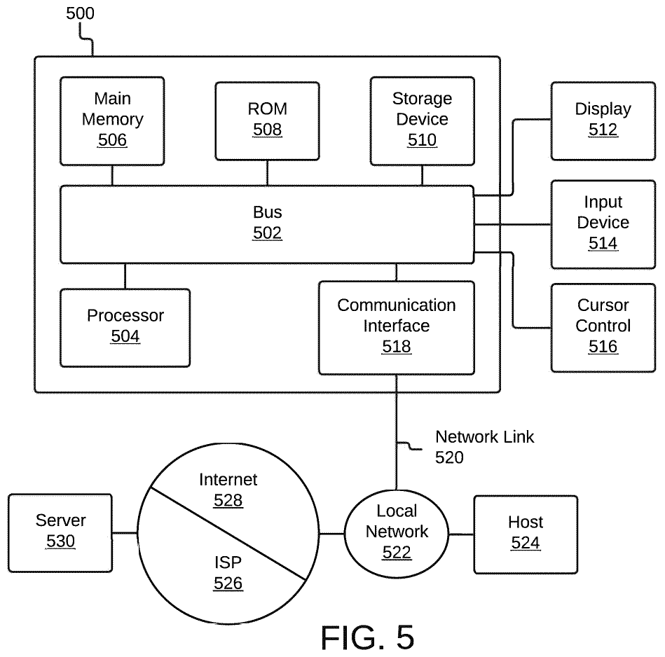

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

What is claimed is:

1. One or more non-transitory computer readable media comprising instructions that, when executed by one or more hardware processors, causes performance of operations comprising:
training a machine learning model to determine a level of information to be captured for a target computation based on a set of training data, the set of training data comprising:
a particular set of attributes corresponding to a particular computation type; and
a particular level of information to be stored in relation to the particular computation type;
determining a first set of attributes associated with a first computation for a first computed value determined for a first field in a form;
applying the trained machine learning model to the first set of attributes to determine a first level of information to be stored in relation to the first computed value;
selecting a first subset of information associated with the first computation and/or the first computed value based on the first level of information determined by the trained machine learning model;
storing the first subset of information in association with the first computed value;
receiving feedback corresponding to the first subset of information; and
retraining the trained machine learning model based on the feedback.

2. The non-transitory computer-readable medium of claim 1, wherein the operations further comprise:
determining a second set of attributes associated with a second computation for a second computed value determined for a second field in the form;
applying the trained machine learning model to a second set of attributes to determine a second level of information to be stored in relation to the second computed value, wherein the first level of information is different than the second level of information;
selecting a second subset of information associated with the second computed value based on the second level of information determined by the trained machine learning model; and
storing the second subset of information in association with the second computed value.

3. The non-transitory computer-readable medium of claim 1, wherein the first level of information comprises a detail associated with the first computation and/or the first computed value.

4. The non-transitory computer-readable medium of claim 1, wherein the first level of information identifies at least one of:
an amount of explanation associated with the first computed value;
sub-computations used for first computation; and
sub-values used for executing the first computation.

5. The non-transitory computer-readable medium of claim 1, wherein the operations further comprise:
receiving a request for details associated with the first computed value; and
presenting the first subset of information in response to the request.

6. The non-transitory computer-readable medium of claim 1, wherein prior to training the machine learning model, the operations further comprise:
monitoring a set of queries associated with different computation types; and
determining information levels to associate with the different computation types based on the set of queries.

7. The non-transitory computer-readable medium of claim 6, wherein the information levels are associated with depth metrics used in the training of the machine learning model.

8. The non-transitory computer-readable medium of claim 1, wherein: the feedback comprises a request for more information associated with the first computed value; and the retraining comprises:
determining a different level of information for storing in association with the first computation based on the feedback; and
training the machine learning model with a second training data set comprising the first computation and the different level of information.

9. The non-transitory computer-readable medium of claim 1, wherein the first computed value depends determined facts and conditional calculations that depend on the determined facts and wherein the first subset of information associated with the first computed value includes some, but not all, of the determined facts and the conditional calculations.

10. The non-transitory computer-readable medium of claim 9 wherein the conditional calculations concern a set of regulations and other conditions that relate to a specific user.

11. The non-transitory computer-readable medium of claim 1 wherein the first set of attributes comprises a computation type of the first computation.

12. A method comprising:
training a machine learning model to determine a level of information to be captured for a target computation based on a set of training data, the set of training data comprising:
a particular set of attributes corresponding to a particular computation type; and
a particular level of information to be stored in relation to the particular computation type;
determining a first set of attributes associated with a first computation for a first computed value determined for a first field in a form;
applying the trained machine learning model to the first set of attributes to determine a first level of information to be stored in relation to the first computed value;
selecting a first subset of information associated with the first computation and/or the first computed value based on the first level of information determined by the trained machine learning model;
storing the first subset of information in association with the first computed value;
receiving feedback corresponding to the first subset of information; and
retraining the trained machine learning model based on the feedback, wherein the method is performed by at least one device including a hardware processor.

13. The method of claim 12, wherein the operations further comprise:
determining a second set of attributes associated with a second computation for a second computed value determined for a second field in the form;
applying the trained machine learning model to a second set of attributes to determine a second level of information to be stored in relation to the second computed value, wherein the first level of information is different than the second level of information;
selecting a second subset of information associated with the second computed value based on the second level of information determined by the trained machine learning model; and
storing the second subset of information in association with the second computed value.

14. The method of claim 12, wherein the first level of information comprises a detail associated with the first computation and/or the first computed value.

15. The method of claim 12, wherein the first level of information identifies at least one of:
an amount of explanation associated with the first computed value;
sub-computations used for first computation; and
sub-values used for executing the first computation.

16. The method of claim 12, wherein the operations further comprise:
receiving a request for details associated with the first computed value; and
presenting the first subset of information in response to the request.

17. A system comprising:
one or more hardware processors;
one or more non-transitory computer-readable media; and
program instructions stored on the one or more non-transitory computer-readable media which, when executed by the one or more hardware processors, cause the system to perform operations comprising:
training a machine learning model to determine a level of information to be captured for a target computation based on a set of training data, the set of training data comprising:
a particular set of attributes corresponding to a particular computation type; and
a particular level of information to be stored in relation to the particular computation type;
determining a first set of attributes associated with a first computation for a first computed value determined for a first field in a form;
applying the trained machine learning model to the first set of attributes to determine a first level of information to be stored in relation to the first computed value;
selecting a first subset of information associated with the first computation and/or the first computed value based on the first level of information determined by the trained machine learning model;
storing the first subset of information in association with the first computed value;
receiving feedback corresponding to the first subset of information; and
retraining the trained machine learning model based on the feedback, wherein the method is performed by at least one device including a hardware processor.

18. The system of claim 17, wherein the operations further comprise:
determining a second set of attributes associated with a second computation for a second computed value determined for a second field in the form;
applying the trained machine learning model to a second set of attributes to determine a second level of information to be stored in relation to the second computed value, wherein the first level of information is different than the second level of information;
selecting a second subset of information associated with the second computed value based on the second level of information determined by the trained machine learning model; and
storing the second subset of information in association with the second computed value.

19. The system of claim 17, wherein the first level of information comprises a detail associated with the first computation and/or the first computed value.

20. The system of claim 17, wherein the first level of information identifies at least one of:
an amount of explanation associated with the first computed value;
sub-computations used for first computation; and
sub-values used for executing the first computation.
